(19) United States
(12) Patent Application Publication
(10) Pub. No.: US 2019/0013511 A1
(43) Pub. Date: Jan. 10, 2019

(54) ELECTRODE SHEET MANUFACTURING METHOD

(71) Applicant: NEC ENERGY DEVICES, LTD., Sagamihara-shi, Kanagawa (JP)

(72) Inventors: Kenji SATO, Kanagawa (JP); Kenichi ITO, Kanagawa (JP); Akira KOBAYASHI, Kanagawa (JP)

(73) Assignee: NEC ENERGY DEVICES, LTD., Sagamihara-shi, Kanagawa (JP)

(21) Appl. No.: 15/737,871

(22) PCT Filed: Jul. 22, 2016
(86) PCT No.: PCT/JP2016/071563

§ 371 Date: Dec. 19, 2017

(30) Foreign Application Priority Data
Jul. 28, 2015 (JP) 2015-148392

(51) Int. Cl. H01M 4/04; H01M 4/70

(52) U.S. Cl. CPC H01M 4/0435; H01M 4/70

(57) ABSTRACT

The present invention provides a method of manufacturing an electrode sheet including a compression step of causing a band-shaped electrode sheet provided with an active substance layer which is an active substance forming portion between at least a pair of rotating columnar compression rolls, and pressing and compressing the electrode sheet by the pair of compression rolls, and a cutting step of cutting the electrode sheet undergoing the compression step parallel to a longitudinal direction of the electrode sheet. When the width of the active substance layer is assumed as a first width, the compression step compresses the electrode sheet using the compression rolls having a second width equal to or less than the first width.

### TECHNICAL FIELD

The present invention relates to a method of manufacturing an electrode sheet which is made into a battery electrode.

### BACKGROUND ART

A battery electrode is created from a band-shaped current collector in which slurry containing an active substance is coated and dried on a metal foil of aluminum, copper or the like. Coating methods for the active substance can be roughly classified into an intermittent coating method and a continuous coating method.

The intermittent coating method is a method whereby active substance forming and non-formed portions are alternately formed at a predetermined interval along a longitudinal direction of the band-shaped current collector. The active substance non-formed portions are used as electrode lead-out tabs for electrical connection with external terminals.

The continuous coating method is a method of continuously forming an active substance in a longitudinal direction of the band-shaped current collector. According to the continuous coating method, active substance non-formed portions are arranged at both ends in a width direction of the current collector parallel to the longitudinal direction of the current collector. The active substance non-formed portions are also used as electrode lead-out tabs in the continuous coating method. Note that the active substance forming portion will be hereinafter called an “active substance layer.”

FIG. 1A is a schematic view illustrating an example of an electrode sheet formed using an intermittent coating method and FIG. 1B is a schematic view illustrating an example of an electrode sheet formed using a continuous coating method.

Dotted lines shown in FIGS. 1A and 1B indicate cutting positions of current collector 12. FIG. 1A shows a situation in which six rows of electrode sheets 10 are cut out from band-shaped current collector 12 and FIG. 1B shows a situation in which two rows of electrode sheets 10 are cut out from band-shaped current collector 12.

As shown in FIGS. 1A and 1B, band-shaped current collector 12 which is coated with slurry and dried is cut parallel to a longitudinal direction thereof to form electrode sheets 10 of a desired width. At this time, according to the intermittent coating method, electrode sheets 10 are formed with active substance layers 11 or active substance non-formed portions being arranged up to both ends in the width direction as shown in FIG. 1A. Furthermore, according to the continuous coating method, electrode sheets 10 are formed such that an active substance non-formed portion is arranged at one end in the width direction and active substance layer 11 is arranged at the other end in the width direction as shown in FIG. 1B. Note that the longitudinal direction of current collector 12 and electrode sheets 10 is assumed to indicate a winding direction of band-shaped current collector 12 and electrode sheets 10, and the width direction is assumed to indicate a direction perpendicular to the longitudinal direction.

FIG. 2 is a schematic view illustrating an electrode sheet compression step. FIG. 3A is a schematic view illustrating a situation in which electrodes are cut out from the electrode sheet formed using the intermittent coating method and FIG. 3B is a schematic view illustrating a situation in which electrodes are cut out from the electrode sheet formed using the continuous coating method. FIG. 2 illustrates a situation in which electrode sheets 10 formed using the intermittent coating method are compressed.

As shown in FIG. 2, electrode sheet 10 cut out from current collector 12 is compressed by a pair of compression rolls 20, and the thickness and density of active substance layer 11 on electrode sheet 10 are thereby made uniform. After that, electrode sheet 10 is cut into a predetermined size according to use (see FIGS. 3A and 3B), laminated or wound with a separator (not shown) interposed in between and sealed into an exterior case (not shown) together with electrolyte. A battery is formed by leading out an external terminal (not shown) from the exterior case via an electrode lead-out tab.

For example, Patent Documents 1 to 4 describe that the electrode sheet manufacturing step includes the compression step.

Patent Document 1 describes that an active substance is divided into a plurality of regions and coated in the width direction of the current collector in order to prevent a difference in thickness of the active substance from being generated between areas close to both ends in the width direction of the current collector and areas close to the central part.

Patent Document 2 proposes conditions of heat treatment to be executed after compression of the electrode sheet in order to reduce variations in thickness of the electrode sheet caused by a viscosity improver, surfactant or binder or the like remaining in dried slurry.

Patent Document 3 describes that creases generated in the active substance non-formed portions provided at an end in the width direction of the electrode sheet are stretched outward of the electrode sheet by compression of the compression roll and the end in the width direction is cut parallel to the longitudinal direction, and the width of the electrode sheet is thereby prevented from moving in the longitudinal direction.

Patent Document 4 describes a press apparatus provided with a first roll portion that compresses an active substance layer and a second roll portion that compresses an active substance non-formed portion in order to prevent creases from being generated on a boundary between the active substance layer and the active substance non-formed portion during compression in the electrode sheet formed using the continuous coating method.

As shown in FIG. 2, the aforementioned compression step is a step of causing the electrode sheet to pass between a pair of rotating columnar compression rolls which are generally wider than the electrode sheet, and thereby pressing and compressing the electrode sheet with the pair of compression rolls.

Since the thickness of the electrode sheet varies between the active substance layer and the active substance non-formed portion, the current collector is compressed with a stronger force in the active substance layer than in the active substance non-formed portion when compressed by the compression rolls. Since the compressed current collector is stretched in a direction parallel to the surface thereof, there is a difference in the amount of the stretched current collector between the active substance layer and the active substance non-formed portion and creases are produced in the current collector. When creases are produced in the current collector, this may possibly affect the quality of batteries in the manufacturing step or after manufacturing such as tearing off of the current collector, dropping off of the active substance near creases and distortion when the electrode sheet is wound up into a roll-like shape.

Furthermore, since concave portions (see FIG. 2) are formed due to abrasion that occurs at the point of contact with the electrode sheet in the compression rolls, the compression rolls need to be replaced periodically. Particularly, when the electrode sheet is compressed in which the active substance layer is arranged even up to an end in the width direction, as in the case of the electrode sheet formed using the intermittent coating method, unnecessary protrusions (burrs) may be generated at an end in the width direction of the electrode sheet and the burrs may cause unintended grooves to be formed in the compression rolls. This may further shorten the life cycle of the compression rolls.

Aforementioned Patent Document 1 or 2 does not show any technique for reducing creases generated in the electrode sheet caused in the compression step or technique for preventing shortening of the life cycle of the compression rolls.

Aforementioned Patent Document 3 does not show the technique for preventing shortening of the life cycle of the compression rolls, but shows a technique for reducing the influence of the creases on the manufacturing step by cutting the creases at an end of the electrode sheet generated in the compression step. Aforementioned Patent Document 4 is a technique for preventing the occurrence of creases themselves in the electrode sheet due to the compression step and burrs never cause grooves to be formed in the compression rolls.

However, since the technique described in Patent Document 3 is premised on the use of the electrode sheet provided with active substance non-formed portions at both ends in the width direction respectively, the problem is that usable electrode sheets are limited. Furthermore, the technique described in Patent Document 3 needs a mechanism for stretching creases generated in the electrode sheet and needs to accurately control the cutting positions of the active substance non-formed portions including the creases. This results in an increase in the size of facilities for manufacturing the electrode sheet and the number of complicated processing steps, causing an increase in the manufacturing cost.

On the other hand, Patent Document 4 shows a compression technique only applicable to an electrode sheet formed using the continuous coating method and the problem is that it is not applicable to an electrode sheet formed using the intermittent coating method.

### RELATED ART DOCUMENTS

### Patent Documents

Patent Document 1: JP2002-304988A
Patent Document 2: JP2008-147114A
Patent Document 3: JP2015-026562A
Patent Document 4: JP2014-103068A

### SUMMARY

It is therefore an object of the present invention to provide a method of manufacturing an electrode sheet capable of reducing the influence of creases of a current collector generated in a compression step and extending the life cycle of compression rolls.

In order to attain the above described object, an exemplary aspect of the method of manufacturing an electrode sheet of the present invention includes a compression step of causing a band-shaped electrode sheet provided with an active substance layer which is an active substance formed portion between at least a pair of rotating compression rolls and pressing and compressing the electrode sheet through the pair of compression rolls, and a cutting step of cutting the electrode sheet undergoing the compression step parallel to a longitudinal direction of the electrode sheet, in which the compression step compresses the electrode sheet using the compression rolls having a second width equal to or less than a first width, where the first width is the width of the active substance layer.

### BRIEF DESCRIPTION OF DRAWINGS

FIG. 1A is a schematic view illustrating an example of an electrode sheet formed using an intermittent coating method.

FIG. 1B is a schematic view illustrating an example of an electrode sheet formed using a continuous coating method.

FIG. 2 is a schematic view illustrating a compression step of the electrode sheet.

FIG. 3A is a schematic view illustrating a situation in which electrodes are cut out from the electrode sheet formed using the intermittent coating method.

FIG. 3B is a schematic view illustrating a situation in which electrodes are cut out from the electrode sheet formed using the continuous coating method.

FIG. 4 is a schematic view illustrating an example of a method of manufacturing an electrode sheet according to a first example embodiment.

FIG. 5A is an outline drawing illustrating an outline of compression rolls used in a method of manufacturing an electrode sheet according to a second example embodiment and cross-sectional views illustrating the electrode sheet after the compression step and the electrode sheet after the cutting step.

FIG. 5B is a schematic view illustrating a procedure for manufacturing an electrode sheet according to the second example embodiment.

FIG. 6A is an outline drawing illustrating an outline of compression rolls used for the method of manufacturing an electrode sheet according to a third example embodiment.

FIG. 6B is a schematic view illustrating a procedure for manufacturing an electrode sheet according to the third example embodiment.

### EXAMPLE EMBODIMENT

Next, the present invention will be described using the accompanying drawings.

### First Example Embodiment

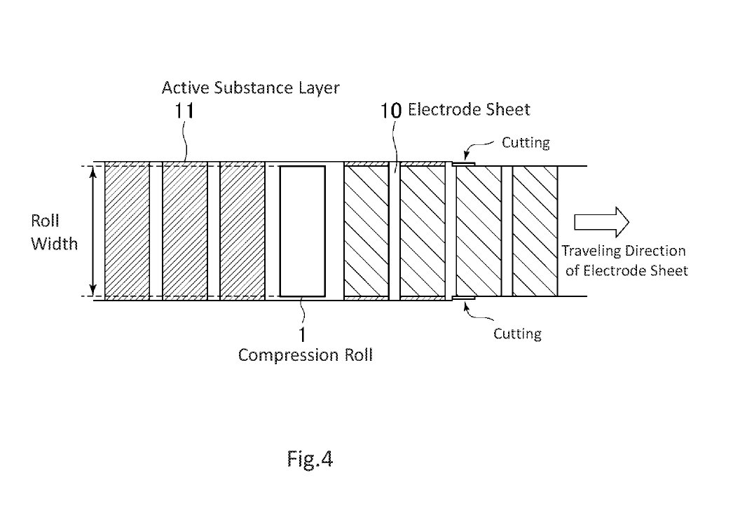

FIG. 4 is a schematic view illustrating an example of a method of manufacturing an electrode sheet according to a first example embodiment. FIG. 4 illustrates a situation in which electrode sheet 10 formed using an intermittent coating method is compressed and cut.

As shown in FIG. 4, in the method of manufacturing an electrode sheet according to the first example embodiment, electrode sheet 10 is compressed first, and then both ends in a width direction of electrode sheet 10 are cut parallel to the longitudinal direction and removed. At this time, according to the first example embodiment, electrode sheet 10 is compressed using compression roll 1 having a roll width equal to or less than the width of active substance layer 11. The roll width may be set to be equal to or less than the width of active substance layer 11 before the compression or may be set to be equal to or less than the width of active substance layer 11 after the compression by taking into consideration the amount of elongation of current collector 12 after compression.

In a cutting step of electrode sheet 10, which is executed after the compression step, both ends in the width direction of electrode sheet 10 are cut parallel to the longitudinal direction respectively, by leaving portions having a width equal to or less than the above-described roll width such that the ends in the width direction of electrode sheet 10, which are not compressed by compression roll 1, are removed.

Setting the roll width of compression roll 1 to be equal to or less than the width of active substance layer 11 on electrode sheet 10 in this way prevents burrs from being generated at ends in the width direction of electrode sheet 10, and can thereby prevent any burr-triggered groove from being formed in compression roll 1. Furthermore, since compression roll 1 in its entire width direction comes into contact with electrode sheet 10, it abrades relatively uniformly, thus preventing any concave parts from being formed in compression roll 1. Therefore, it is possible to extend the life cycle of compression roll 1.

According to the method of manufacturing an electrode sheet of the first example embodiment, the compression step is executed first, and then the ends in the width direction of electrode sheet 10, which are not compressed by compression roll 1, are cut and removed, and it is thereby possible to make uniform the thickness of active substance layer 11 on electrode sheet 10. Furthermore, since the ends in the width direction of electrode sheet 10, which are not compressed by compression roll 1, also include creases of current collector 12 generated in the compression step, cutting and removing the ends also reduce the quantity of active substance that falls off due to creases in current collector 12. This makes it possible to reduce the influence of creases of current collector 12 generated in the compression step.

As described above, since electrode sheet 10 after the processing is wound into a roll-like shape and sent to the next step, the thickness of active substance layer 11 becomes uniform, which also prevents distortion from occurring in electrode sheet 10 wound into a roll-like shape.

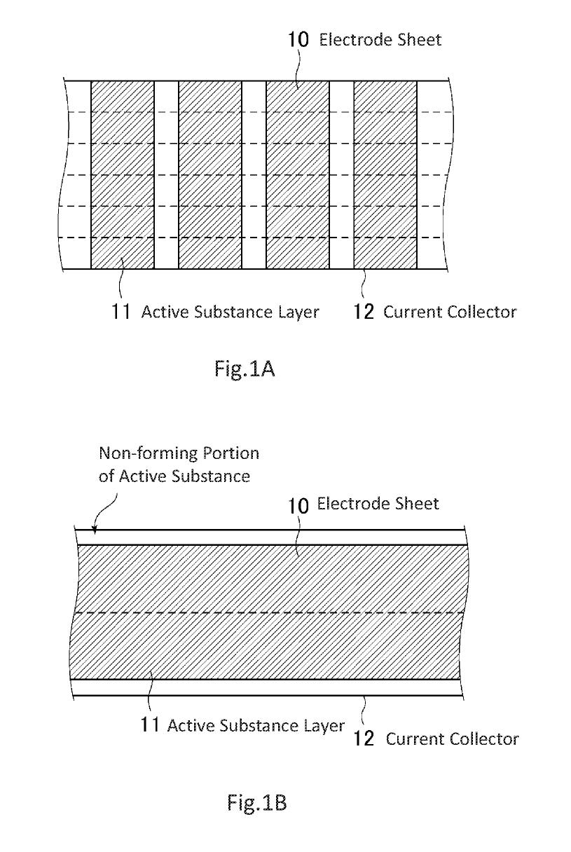

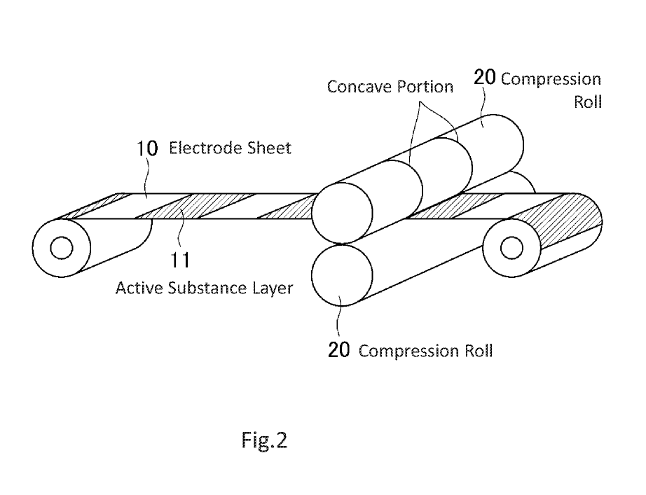

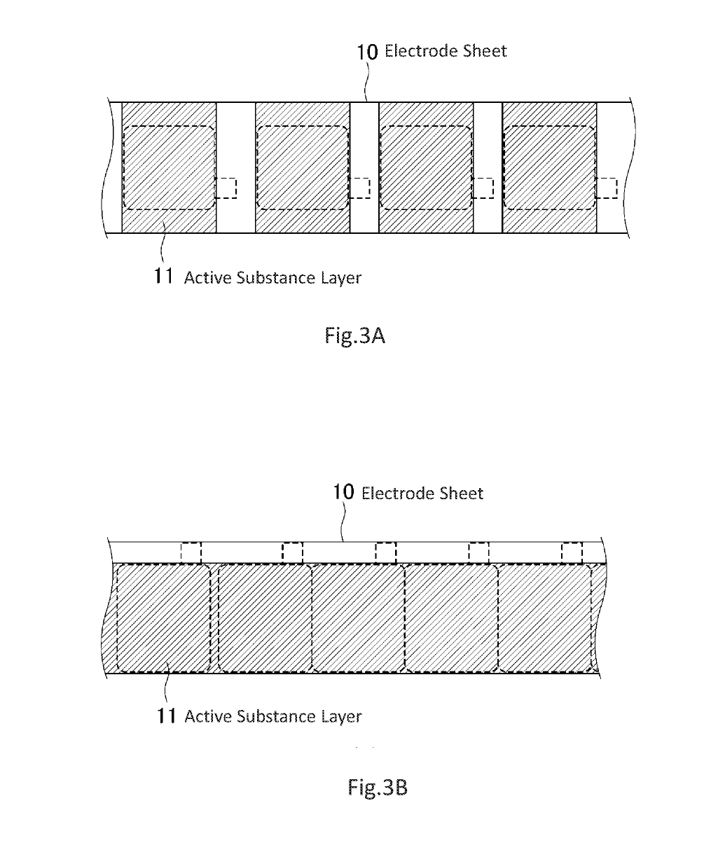

Note that in electrode sheet 10 including an active substance non-formed portion at one end in the width direction as in the case of the electrode sheet (see FIG. 1B) formed using the continuous coating method, the active substance non-formed portion needs to be left as the aforementioned electrode lead-out tab. Therefore, if such electrode sheet 10 is compressed by compression rolls 1 having a smaller width than that of active substance layer 11, relatively thick active substance layer 11 remains on a boundary with the active substance non-formed portion.

Therefore, when electrode sheet 10 including the active substance non-formed portion at one end in the width direction is compressed, the width of compression roll 1 may be made to substantially match the width of active substance layer 11. That is, the method of manufacturing an electrode sheet of the example embodiment is also applicable to electrode sheet 10 that is formed using the continuous coating method.

According to the example embodiment, since ends in the width direction of electrode sheet 10 including active substance layer 11 that is not compressed by compression rolls 1 after the compression step are cut and removed, it is possible to make the thickness of active substance layer 11 on electrode sheet 10 uniform and reduce the influence of creases of current collector 12 generated in the compression step. Furthermore, setting the width of compression rolls 1 to be equal to or less than the width of active substance layer 11 on electrode sheet 10 prevents concave parts or grooves from being formed in compression roll 1, and can thereby extend the life cycle of compression rolls 1.

Furthermore, the example embodiment eliminates the necessity for a mechanism for stretching creases generated in electrode sheet 10 or the necessity for accurately controlling the cutting position in the active substance non-formed portion including the creases as in the case of the technique described in aforementioned Patent Document 3. Therefore, it is possible to reduce any increases in the manufacturing cost for manufacturing electrode sheet 10.

Moreover, the method of manufacturing an electrode sheet according to the example embodiment is not limited to electrode sheet 10 formed using the continuous coating method as in the case of the technique described in aforementioned Patent Document 4, but is also applicable to electrode sheet 10 formed using the intermittent coating method.

### Second Example Embodiment

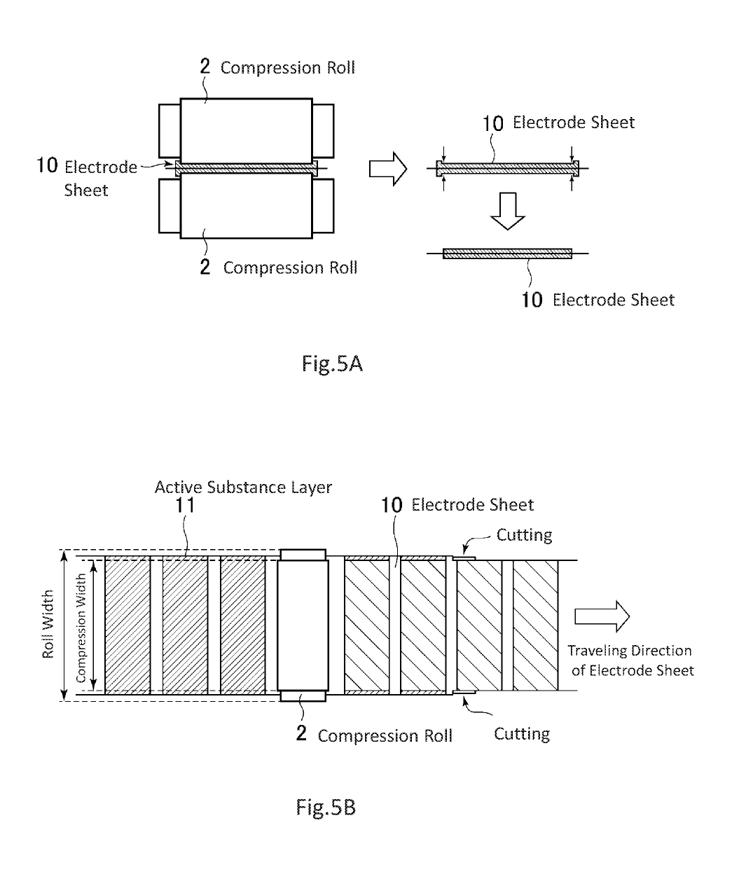

FIG. 5A is an outline drawing illustrating an outline of compression rolls used for the method of manufacturing an electrode sheet according to a second example embodiment and cross-sectional views illustrating the electrode sheet after the compression step and the electrode sheet after the cutting step. FIG. 5B is a schematic view illustrating a procedure for manufacturing an electrode sheet according to the second example embodiment. FIG. 5B illustrates a situation in which electrode sheet 10 that is formed using the intermittent coating method is compressed and cut.

A method of manufacturing an electrode sheet according to the second example embodiment is a method whereby electrode sheet 10 is compressed first as in the case of the first example embodiment, and then cut such that both ends in the width direction of electrode sheet 10 become parallel to the longitudinal direction. In the second example embodiment, the compression width by compression rolls 2 is set to be equal to or less than the width of active substance layer 11 on electrode sheet 10 using compression rolls 2 having a small roll diameter at both ends in the width direction as shown in FIGS. 5A and 5B. The rest of the configuration and manufacturing method are similar to those of the first example embodiment, and so description thereof is omitted.

The second example embodiment using compression rolls 2 shown in FIGS. 5A and 5B can also obtain effects similar to those in the first example embodiment.

### Third Example Embodiment

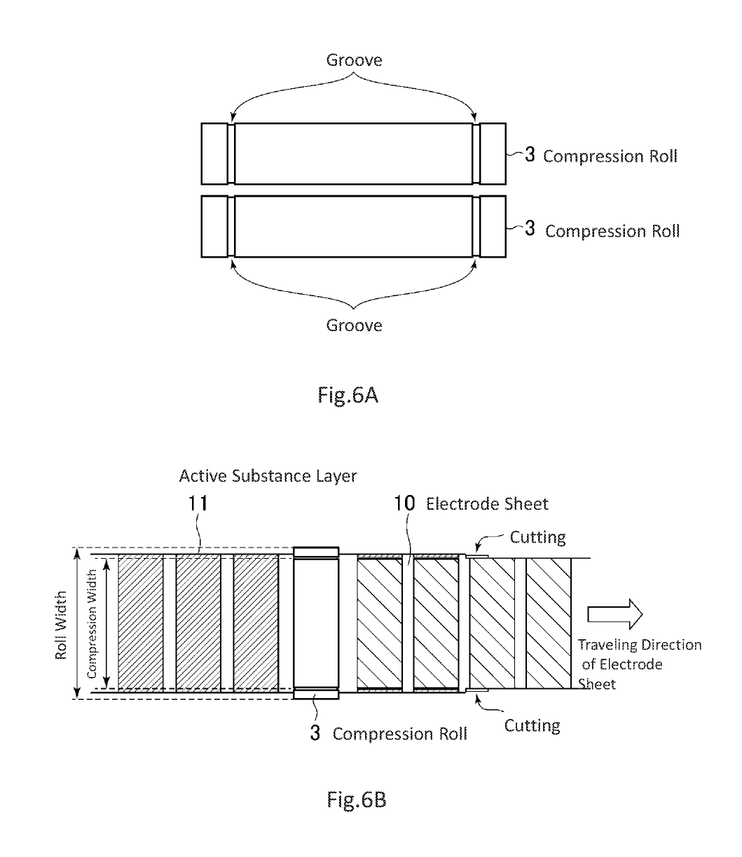

FIG. 6A is an outline drawing illustrating an outline of compression rolls used for a method of manufacturing an electrode sheet according to a third example embodiment and FIG. 6B is a schematic view illustrating a procedure for manufacturing the electrode sheet according to the third example embodiment. FIG. 6B illustrates a situation in which electrode sheet 10 that is formed using the intermittent coating method is compressed and cut.

As in the case of the first example embodiment, the method of manufacturing an electrode sheet according to the third example embodiment is a method whereby electrode sheet 10 is compressed first, and then both ends in the width direction of electrode sheet 10 are cut parallel to the longitudinal direction. As shown in FIGS. 6A and 6B, the third example embodiment uses compression rolls 3 that are provided with grooves at positions corresponding to ends of the active substance layer on electrode sheet 10 to make a substantial compression width by compression rolls 3 equal to or less than the width of active substance layer 11 on electrode sheet 10. The rest of the configuration and manufacturing method are similar to those of the first example embodiment, and so description thereof is omitted.

The third example embodiment using compression rolls 3 shown in FIGS. 6A and 6B can also obtain effects similar to those of the first example embodiment.

The present invention has been described so far with reference to the example embodiments, but the present invention is not limited to the above-described example embodiments. Various modifications understandable to those skilled in the art within the scope of the present invention may be made with respect to the configuration or the details of the present invention.

The present application claims a priority based on JP2015-148392A, filed on Jul. 28, 2015, the disclosure of which is incorporated herein by reference in its entirety.

1. A method of manufacturing an electrode sheet comprising:
a compression step of causing a band-shaped electrode sheet provided with an active substance layer which is an active substance forming portion between at least a pair of rotating columnar compression rolls, and pressing and compressing said electrode sheet through the pair of compression rolls; and
a cutting step of cutting said electrode sheet undergoing said compression step parallel to a longitudinal direction of said electrode sheet, wherein
said compression step compresses said electrode sheet using the compression rolls having a second width equal to or less than a first width, where the first width is the width of the active substance layer.

2. The method of manufacturing an electrode sheet according to claim 1, wherein
said compression step compresses said electrode sheet by the compression rolls having a fourth width equal to or less than a third width, where the third width is a width of said electrode sheet extended in a width direction perpendicular to a longitudinal direction of said electrode sheet when said band-shaped electrode sheet is compressed.

3. The method of manufacturing an electrode sheet according to claim 1, wherein
said cutting step cuts both ends in the width direction of said electrode sheet parallel to the longitudinal direction by leaving portions having a width equal to or less than the width of the compression rolls such that the ends in the width direction perpendicular to the longitudinal direction of said electrode sheet which are not compressed by the pair of compression rolls are removed.

4. The method of manufacturing an electrode sheet according to claim 1, wherein said electrode sheet comprises the active substance layers and the active substance non-formed portions alternately arranged in the longitudinal direction at a predetermined interval.

5. The method of manufacturing an electrode sheet according to claim 2, wherein
said cutting step cuts both ends in the width direction of said electrode sheet parallel to the longitudinal direction by leaving portions having a width equal to or less than the width of the compression rolls such that the ends in the width direction perpendicular to the longitudinal direction of said electrode sheet which are not compressed by the pair of compression rolls are removed.

6. The method of manufacturing an electrode sheet according to claim 2, wherein said electrode sheet comprises the active substance layers and the active substance non-formed portions alternately arranged in the longitudinal direction at a predetermined interval.

7. The method of manufacturing an electrode sheet according to claim 3, wherein said electrode sheet comprises the active substance layers and the active substance non-formed portions alternately arranged in the longitudinal direction at a predetermined interval.

8. The method of manufacturing an electrode sheet according to claim 5, wherein said electrode sheet comprises the active substance layers and the active substance non-formed portions alternately arranged in the longitudinal direction at a predetermined interval.
